(19) United States
(12) Patent Application Publication
(10) Pub. No.: US 2020/0091580 A1
(43) Pub. Date: Mar. 19, 2020

(54) TELESCOPING AND FLEXIBLE ANTENNA

(71) Applicant: Larry F. Katzin, Raleigh, NC (US)

(72) Inventor: Larry F. Katzin, Raleigh, NC (US)

(21) Appl. No.: 16/555,992

(22) Filed: Aug. 29, 2019

Related U.S. Application Data
(60) Provisional application No. 62/724,676, filed on Aug. 30, 2018.

(51) Int. Cl. H01Q 1/10; H01Q 1/08; H01Q 1/36; H01Q 1/12

(52) U.S. Cl. CPC H01Q 1/10; H01Q 1/085; H01Q 1/12; H01Q 1/084; H01Q 1/36

(57) ABSTRACT

A telescoping antenna has a first hollow tubular coiled spring and a second hollow tubular coiled spring with a relatively consistent diameter from a distal end to a proximal end. The second spring is nested inside the first spring when in a stored position. A shim is coupled to a proximal end of the second spring. A diameter of the shim is greater than the diameter of a second spring.

### CROSS REFERENCE TO RELATED APPLICATIONS

The present application claims the benefit of priority to U.S. Provisional Application No. 62/724,676 filed Aug. 30, 2018, the disclosure of which is incorporated herein in its entirety by reference.

### FIELD OF THE DISCLOSURE

The disclosure relates generally to the field of antennas. More specifically, the disclosure relates to the field of telescoping and flexible antennas.

### SUMMARY

The following presents a simplified summary of the disclosure in order to provide a basic understanding of some aspects of the disclosure. This summary is not an extensive overview of the disclosure. It is not intended to identify critical elements of the disclosure or to delineate the scope of the disclosure. Its sole purpose is to present some concepts of the disclosure in a simplified form as a prelude to the more detailed description that is presented elsewhere.

In one embodiment, an antenna comprises a first flexible tubular coiled spring and one or more additional flexible tubular coiled springs. A diameter of the one or more springs is generally less than a diameter of the first spring so the one or more springs can be nested serially within the first spring. The first and one or more springs are telescoping elements and radiating elements, and at least a portion of the first and one or more springs is exposed when the antenna is in an extended position.

In another embodiment, a telescoping antenna comprises a first hollow tubular coiled spring and a second hollow tubular coiled spring having a relatively consistent diameter from a distal end to a proximal end. The second spring is nested within the first spring when in a stored position. A first shim may be coupled to a proximal end of the second spring, and a diameter of the first shim is greater than a diameter of the second spring.

In yet another embodiment, an antenna comprises a first flexible hollow cylindrical spring having a distal end and a proximal end, a second flexible hollow cylindrical spring having a distal end and a proximal end, wherein the second spring is nested within the first spring when in a stored position, and a third flexible hollow cylindrical spring having a distal end and a proximal end, wherein the third spring is nested within the first and second springs when in a stored position. The antenna further comprises a first shim coupled to the proximal end of the second spring, wherein a diameter of the first shim is greater than a diameter of the second spring, a second shim coupled to the proximal end of the third spring, wherein a diameter of the second shim is greater than a diameter of the third spring, a first cap coupled to the distal end of the first spring, a second cap coupled to the distal end of the second spring, and a nub coupled to the distal end of the third spring.

### BRIEF DESCRIPTION OF THE SEVERAL VIEWS OF THE DRAWINGS

Illustrative embodiments of the present disclosure are described in detail below with reference to the attached drawing figures and wherein:

FIG. 1 is a view of an antenna in a stored position, the antenna being coupled to a radio housing;

FIG. 2 is a view of the antenna of FIG. 1 coupled to a radio housing and in an extended position;

FIG. 3 is a cross sectional view of the antenna of FIG. 1; and

FIG. 4 is a perspective view of the antenna of FIG. 1 in an extended position showing the flexibility of the antenna.

FIG. 5 is a view of the antenna of FIG. 1 as it is used in connection with a communications unit.

### DETAILED DESCRIPTION

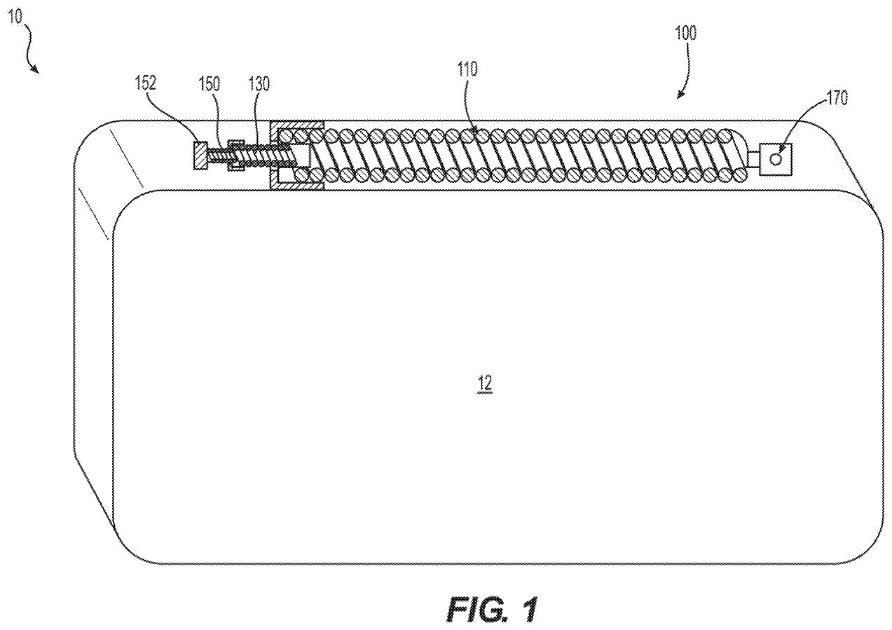

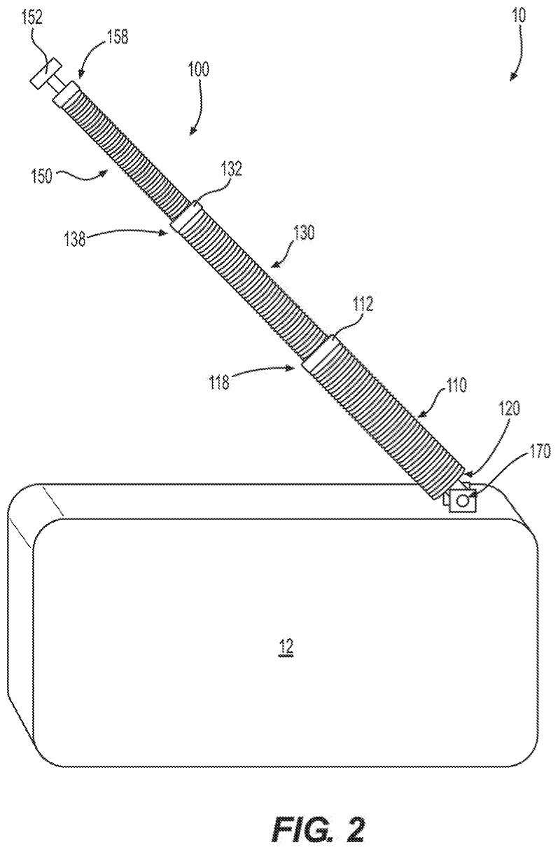

FIGS. 1 through 5 show in part an antenna 100 according to one embodiment of the current invention. As shown in FIG. 1, a radio 10 has a housing 12 and an antenna 100. The antenna 100 may include, in one embodiment, three hollow springs 110, 130, 150, a nub 152, and a mounting mechanism 170. FIG. 1 shows the antenna 100 in a stored position. The antenna 100 has a telescoping function in that portions thereof may be serially nested within other portions of the antenna 100. In some embodiments, the antenna 100 may have hollow springs that nest serially within one another. The springs 110, 130, 150 as shown in FIG. 1 may generally be tubular and have a lumen. The springs 110, 130, 150 may be generally cylindrical. Alternately, the springs 110, 130, 150 may be any shape, such as triangular. In some embodiments the springs 110, 130, 150 may maintain a relatively consistent diameter from proximal ends 120, 140, 160 to distal ends 118, 138, 158 (as shown in FIG. 2).

The antenna 100 may be constructed of any appropriate electrically conductive material, such as silver, copper, zinc, aluminum, steel, or any other metal or composite now known or later discovered. The antenna 100 may have a telescoping component and a radiating component.

The springs 110, 130, 150 may be substantially cylindrical helical coils. In some embodiments, the coils of the springs 110, 130, 150 may be adjacent to one another such that the coils abut one another in a resting position. The springs 110, 130, 150 may be configured to be flexible and moveable such that the coils may separate or flex when a force is applied to the springs 110, 130, 150. This may allow the antenna 100 to bend and flex. In contrast, if a force were applied to a rigid antenna the antenna may snap. In other embodiments the coils of the springs 110, 130, 150 may be extended such that there is visible space between each coil.

The springs 110, 130, 150 may also include an inflexible portion. In some embodiments, the springs 110, 130, 150 may comprise flexible cylindrical helical coils at the proximal 120, 140, 160 and distal ends 118, 138, 158, and may have a rigid section in a substantially central area of the springs 110, 130, 150. In other embodiments, the springs 110, 130, 150 may have multiple rigid sections. At least one third of a length of each spring 110, 130, 150 may be comprised of helical coils. In some embodiments, the first spring 110 may be comprised substantially of helical coils, and the second 130 and third 150 springs may be comprised substantially of rigid sections.

The springs 110, 130, 150 may each have a diameter. The springs 110, 130, 150 may also each have an inner diameter that is defined by a circumference of an interior surface of the springs 110, 130, 150. Additionally, the springs 110, 130, 150 may have an outer diameter that is defined by a circumference of an exterior surface of the springs 110, 130, 150.

In some embodiments, and as shown in FIGS. 1, 2, and 4, the nub 152 may be coupled to the distal end 158 of the third spring 150. The nub 152 may assist with ease of use when transitioning the antenna 100 from a stored position to an extended position. The nub 152 may have a diameter that may be greater than the diameter of the third spring 150 to prevent the third spring 150 from descending entirely within the second spring 130. Alternately, the nub 152 may have a diameter that may be greater than the diameter of the second spring 130.

As shown in FIGS. 1 and 2, the antenna 100 may be coupled to the housing 12 of the radio 10. In one embodiment, the antenna 100 may have a blade at a proximal end of the antenna 100 (not shown). The blade may have at least one aperture so that the antenna 100 may be secured to the mounting mechanism 170. The aperture may be approximately in the center of the blade. The blade may further have rounded edges.

The mounting mechanism 170 may have a slot (not shown) to receive the blade, and may be generally cylindrical. The mounting mechanism 170 may interact with the first spring 110 in order to provide electrical continuity. The mounting mechanism 170 may also have at least one aperture to secure the antenna 100 to the housing 12. At least one of the at least one aperture of the mounting mechanism 170 and the aperture of the blade may be threaded so that they may be secured, for example, with a screw. In one embodiment, the mounting mechanism 170 has two apertures whereby a screw may be passed through. When the blade is passed through the slot, the aperture of the blade may align with the apertures of the mounting mechanism, thereby allowing the antenna 100 to be secured to the mounting mechanism 170. The antenna 100 may be coupled to the mounting mechanism 170 such that the antenna 100 may move in an arc about the screw. In other embodiments, the mounting mechanism 170 may be coupled to the antenna 100 in a ball and socket type coupling, or other hinge connection now known or later discovered. In some embodiments, the antenna 100 may be coupled to the mounting mechanism 170 such that the antenna can move along the x, y, and z axes. In other embodiments, the antenna 100 has a 365 degree range of motion. The antenna 100 may alternately be coupled to the mounting mechanism 170 through any reasonable means now known or later developed.

The mounting mechanism 170 may further comprise a spiral spring section (not shown). The spiral spring section may further allow the antenna to bend and flex to prevent snapping. The spiral spring section may be coupled to the housing 12 and the mounting mechanism 170.

In other embodiments, the housing 12 may have a receiving area for receiving the antenna 100 when it is in a stored position. This may allow the antenna 100 to be fully housed within the housing 12 such that it may be protected. In some embodiments, the antenna 100 may simply extend from the housing 12 and may not be moveable about a mounting mechanism 170. The antenna 100 may be deployed from the receiving area mechanically by pulling on the nub to extend the antenna. Alternately, the antenna may be deployed using any other means now known or later developed. In some embodiments, the first spring 110 is coupled to a base of the receiving area. In other embodiments, the first spring 110 is coupled to the mounting mechanism 170 at the base of the receiving area. In some embodiments, the mounting mechanism 170 may substantially similar to the mounting mechanism 170 described above and coupled to the housing. The mounting mechanism 170 may be positioned on a platform that rises as the antenna 100 is deployed. In some embodiments the mounting mechanism may extend at least partially outside of the receiving area.

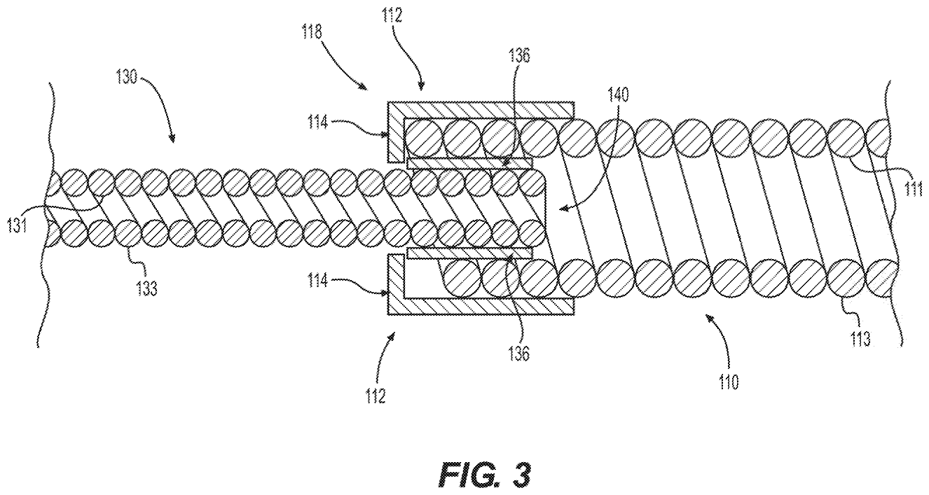

As is shown in FIG. 3, the first spring 110 may have an interior surface 111 and an exterior surface 113. The second spring 130 may also have an interior surface 131 and an exterior surface 133. A diameter of the third spring 150 (not shown in FIG. 3) may be generally less than a diameter of the second spring 130 such that the third spring 150 may nest within the second spring 130 when in a stored position. The diameter of the second spring 130 may be generally less than a diameter of the first spring 110 such that the second spring 130 may nest within the first spring 110 when in the stored position. In other embodiments, there may be four or more portions of the antenna 100 that serially nest within one another. The antenna 100 may have an extended position. When in the extended position, at least a portion of the second spring 130 may be exposed. At least a portion of the third spring 150 may also be exposed. The antenna 100 may alternate between the extended position and the stored position. Additionally, the antenna 100 may be used in any position between the extended position and the stored position.

The springs 110, 130, 150 may be coupled to one another using any means now known or later discovered. As is shown in FIG. 3, the springs 110, 130, 150 are slideably coupled to one another. The springs 110, 130, 150 may be slideably coupled using any means now known or later discovered. In embodiments containing more than three springs 110, 130, 150, the springs may also be connected using caps, crimps, and shims, or any other method of enlargement or diminution known by a person having ordinary skill in the art. In some embodiments, the springs 110, 130, 150 may be coupled together, for example, by using a stop or diminution coupled to a first end of the springs 110, 130, 150, and an enlargement coupled to a second end of the springs 110, 130, 150. The stop may be a cap and crimp, and the diminution may be a shim.

The caps, crimps, and shims may be constructed of any appropriate electrically conductive material, such as silver, copper, zinc, aluminum, steel, or any other metal or composite now known or later discovered.

Shims are merely illustrative of enlargements which may be provided at the proximal end 120, 140, 160 of a spring 110, 130, 150. Other forms of enlargement may include, but are not limited to, flaring of the proximal end 120, 140, 160 of the springs 110, 130, 150, coating of the proximal end 120, 140, 160 with solder or molten metal, as well as all other manufacturing methods now known or later discovered which may be employed to create the desired enlargement at the proximal end 120, 140, 160 of the springs 110, 130, 150.

Caps are merely illustrative of diminutions in the interior diameter of the springs 110, 130, 150 that results in a diminished lumen proximate the distal end 118, 138, 158 of the springs 110, 130, 150. Other forms of diminution may include, but are not limited to, crimping a distal end 118, 138, 158 of the springs, coating the interior surface 113, 133, 153 with solder or molten metal, as well as all other manufacturing methods now known or later discovered which may be employed to create the desired reduction of the lumen at the distal end 118, 138, 158 of the springs 110, 130, 150.

As is shown in FIG. 3, the proximal end 140 of the second spring 130 may be slid toward the distal end 118 of the first spring 110 as the antenna 100 is extended. A shim 136 may be coupled to the proximal end 140. The shim 136 has a diameter that may be greater than the diameter of the second spring 130 and less than the diameter of the first spring 110.

A cap 112 may be coupled to the distal end 118 of the first spring 110. The cap 112 may have a crimp 114 that extends above and over the distal end 118. An interior diameter of the crimp 114 may be smaller than the diameter of the first spring 110, and larger than the diameter of the second spring 130. The crimp 114 interacts with the shim 136 to retain the second spring 130 at least partially within the first spring 110. When engaged, the cap 112, crimp 114, and shim 136 may have mechanical and electrical continuity with each other and with the springs 110, 130 such that the springs 110, 130 may serve as radiating elements in addition to telescoping elements. In some embodiments, the springs 110, 130, 150 may pop or lock into place when engaged, which may further secure the mechanical and electrical continuity.

In one embodiment, there is a second cap 132, crimp, and shim interaction between the second spring 130 and the third spring 150 (not shown). The second cap 132, crimp, and shim interaction may be substantially similar to the cap 112, crimp 114, and shim 136 interaction described immediately above. The second cap 132 may be coupled to the distal end of the second spring 130. The second cap 132 has a second crimp that has a diameter that may be smaller than the diameter of the second spring 130, and larger than the diameter of the third spring 150. The second crimp interacts with the second shim and retains the third spring 150 at least partially within the second spring 130. When engaged, the second crimp, cap, and shim may have mechanical and electrical continuity with each other and with the springs 130, 150 such that the springs 130, 150 serve as radiating elements in addition to telescoping elements. Alternately, the coils may interact with the enlargement and diminution such that there is constant electrical and mechanical continuity. The springs 110, 130, 150 may thus act as radiating elements even when not fully in an extended position.

A cap and crimp may be coupled to the distal end 158 of the third spring 150, and the nub 152 may be further coupled to the cap and crimp. It is foreseen that in other embodiments, the antenna 100 may be constructed from more than three springs. In these embodiments, each hollow spring has a cap with a crimp at a distal end of the spring, and each serially nested spring has a shim at a proximal end of the spring. In some embodiments, the innermost nested spring may not have a cap with a crimp at a distal end, but may instead be coupled to a nub.

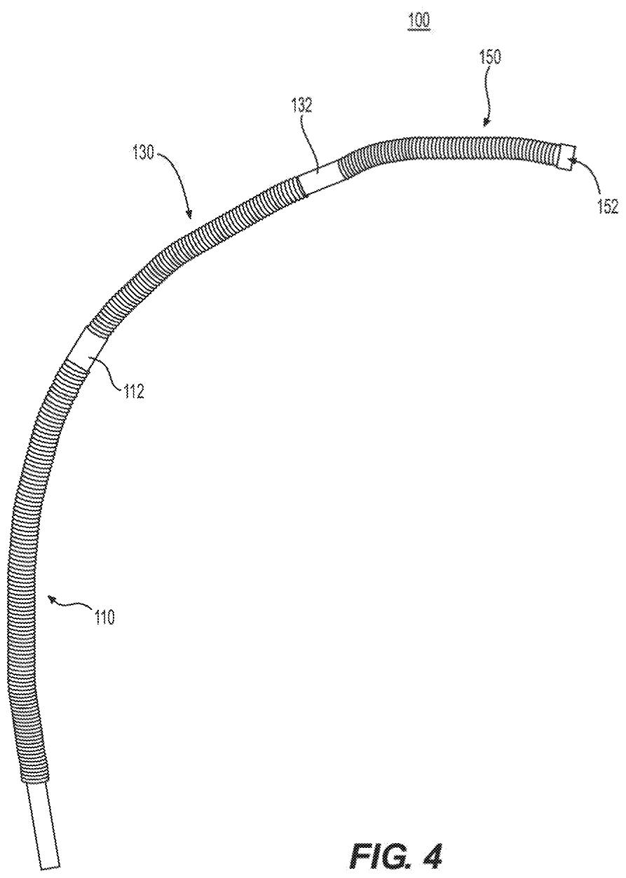

The flexible nature of the antenna 100 is depicted in FIG. 4. It may be desirable for the antenna 100 to be flexible and unrigid. For example, telescoping antennas 100 are commonly used in connection with portable radios. The antenna 100 in the present invention may also be used in connection with portable radios, as well as other radios or applications where a flexible antenna would be desirable. In the present invention, the antenna 100 may be bent and flexed without fear of snapping the antenna 100. The telescoping function allows for easy portability and storage, and a user may extend the antenna 100 in inclement or highly windy weather without the antenna snapping or breaking.

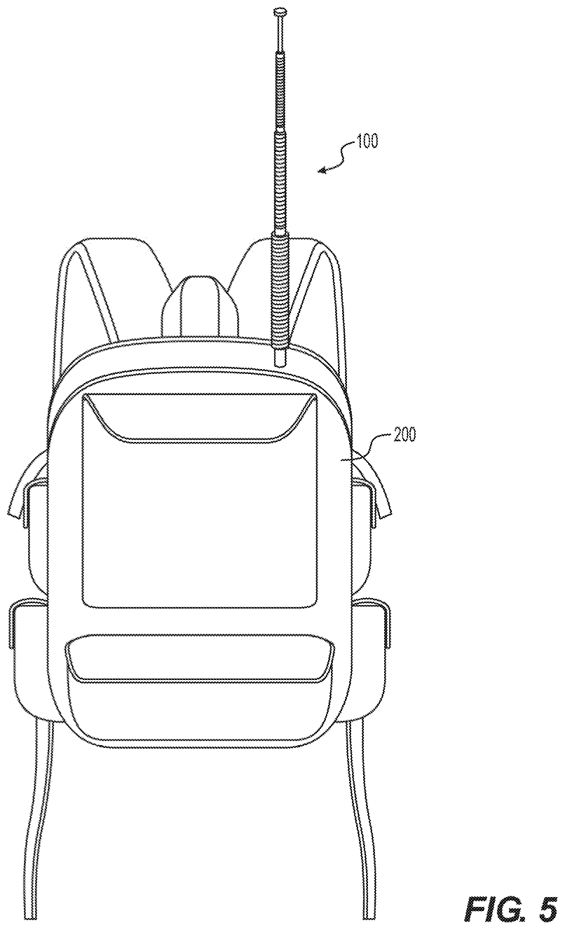

The radio 10 may be used in connection with military or police operations. The radio 10 may be a military grade radio. In some embodiments, as is shown in FIG. 5, the radio 10 may be housed in a backpack 200. The antenna 100 may be deployed and extend outside of the backpack 200. The antenna 100 may contain a rigid element coupled to the nub 152 as shown in FIG. 5. In other embodiments, the housing 12 of the radio 10 may include a clip, hook and loop fastener, or other attachment means now known or later discovered for coupling the radio to an article of clothing such as a belt.

In some embodiments, the antenna 100 is flexible and may have spring elements at advantageous points along the length of the antenna 100. This may allow the antenna 100 to flex rather than being snapped and broken. The antenna 100 may be comprised of separate sections that may be assembled and disassembled allowing for easy storage. Alternately, the antenna 100 may be collapsible along hinges, and the spring elements may be coupled to the antenna 100 proximate the hinges. The spring elements may serve as flex points.

In another embodiment, the antenna 100 may be a fixed length antenna. One or more of the spring elements may be employed along the axis of the antenna 100. It is foreseeable that multiple antennas may be assembled to form a single antenna by using the spring elements as joints. In some embodiments, a spring element may be coupled at the distal end of the antenna, which may allow for greater flexibility and movement of the antenna 100.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

The disclosure claimed is:

1. An antenna comprising:
a first flexible tubular coiled spring; and
one or more additional flexible tubular coiled springs, wherein a diameter of the one or more springs is generally less than a diameter of the first spring so the one or more springs can be nested serially within the first spring;
wherein the first and one or more springs are telescoping elements and radiating elements, and at least a portion of the first and one or more springs is exposed when the antenna is in an extended position.

2. The antenna of claim 1, wherein the coiled springs each have a diameter that is relatively consistent from a proximal end of each spring to a distal end of each spring.

3. The antenna of claim 1, wherein each coiled spring has a cap with a crimp at a distal end of each spring.

4. The antenna of claim 3, wherein the serially nested coiled springs have a shim at a proximal end of each spring.

5. The antenna of claim 4, wherein when the antenna is in an extended position, the cap and the shims maintain electrical continuity between the springs.

6. The antenna of claim 1, wherein the antenna is coupled to a radio.

7. The antenna of claim 1, further comprising:
a blade at a proximal end of the antenna;
a mounting mechanism having a slot to receive the blade, the slot and the blade having an aperture for securing the antenna to the mounting mechanism.

8. The antenna of claim 7, further comprising a spiral spring section coupled to the mounting mechanism.

9. The antenna of claim 1, wherein there are two coiled springs nested serially within the first spring.

10. The antenna of claim 9, further comprising a nub coupled to a distal end of the innermost spring.

11. The antenna of claim 1, wherein the antenna has a stored position in which the one or more springs serially nest within the first spring.

12. A telescoping antenna comprising:
a first hollow tubular coiled spring;
a second hollow tubular coiled spring having a relatively consistent diameter from a distal end to a proximal end, wherein the second spring is nested within the first spring when in a stored position; and
a shim coupled to a proximal end of the second spring, wherein a diameter measured from an outer surface of the shim is greater than a diameter of the second spring.

13. The telescoping antenna of claim 12, further comprising a cap with a crimp coupled to a distal end of the first spring having a diameter that is less than a diameter of the first spring.

14. The telescoping antenna of claim 13, wherein when the antenna is in an extended position, the cap and the shim maintain electrical continuity between the springs.

15. The telescoping antenna of claim 12, further comprising:
a blade at a proximal end of the antenna;
a mounting mechanism having a slot to receive the blade, the slot and the blade having an aperture for securing the antenna to the mounting mechanism.

16. The antenna of claim 15, further comprising a spiral spring section coupled to the mounting mechanism.

17. The telescoping antenna of claim 15, wherein the mounting mechanism is coupled to a radio case.

18. The telescoping antenna of claim 12, wherein the antenna is flexible.

19. An antenna comprising:
a first flexible hollow cylindrical spring having a distal end and a proximal end;
a second flexible hollow cylindrical spring having a distal end and a proximal end, wherein the second spring is nested within the first spring when in a stored position;
a third flexible hollow cylindrical spring having a distal end and a proximal end, wherein the third spring is nested within the first and second springs when in a stored position;
a first shim coupled to the proximal end of the second spring, wherein a diameter of the first shim is greater than a diameter of the second spring;
a second shim coupled to the proximal end of the third spring, wherein a diameter of the second shim is greater than a diameter of the third spring;
a first cap coupled to the distal end of the first spring;
a second cap coupled to the distal end of the second spring; and
a nub coupled to the distal end of the third spring.

20. The antenna of claim 19, wherein the first cap has a first crimp having an interior diameter that is less than a diameter of the first spring, and the second cap has a second crimp having an interior diameter that is less than a diameter of the second spring.
